(19) United States
(12) Patent Application Publication
(10) Pub. No.: US 2004/0008263 A1
(43) Pub. Date: Jan. 15, 2004

(54) Internet-enabled photographing system

(76) Inventors: Craig P. Sayers, Menlo Park, CA (US); Evan R. Kirshenbaum, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 10/192,429

(22) Filed: Jul. 9, 2002

(51) Int. Cl. H04N 5/225; H04N 5/232; H04N 5/76

(52) U.S. Cl. 348/207.11; 348/375; 348/552; 348/211.3; 348/231.3

(57) ABSTRACT

An Internet-enabled photographing system includes a photographing module that, when activated, records an image. A code generator generates and associates an identifying code with the image. An output module notifies the user of the photographing system the identifying code. A server allows external access to the image with the identifying code via the Internet.

### BACKGROUND OF THE INVENTION

1. Field of the Invention

The present invention pertains to photographing systems. More particularly, this invention relates to an Internet-enabled photographing system that provides vending-machine type service.

2. Description of the Related Art

A camera is a type of imaging device through which a viewer can view and record a scene (and/or people) of interest. The term scene typically refers to building, building complex, wall, castle, palace, temple/church, mosque, billboard, statue, road, freeway/highway, railway, bridge, harbor, airport, bus/rail/underground station, monument, mountain, rock, tree, forest, island, ocean, sea, bay, strait, river, lake, creek, reservoir, or dam, etc. As a matter of fact, the term scene hereinafter refers to any natural or man-made physical object or point of interest.

A camera typically includes optical arrangements that can present a scene to its viewer. The optical arrangements include a lens that can make distant scene appear nearer and larger to its viewer. The lens can be fixed lens or zoom lens. However, the main function of a camera is to record images captured by its optical arrangements on some medium (e.g., film, video tape, or electronic storage module). The recorded images can be in the form of still pictures or moving pictures.

There are many different kinds of cameras. A conventional camera records images on films. A video camera records images on video tapes. A digital camera records images digitally and stores the digital images on electronic storage media (e.g., flash memory card).

A camera is typically needed when a person at or near a scene wants to take a photograph of the scene. In addition, if the person wants to take a photograph of herself with the scene, she typically needs to set the camera on a tripod so she can be freed to stand in front of the camera and let the camera captures the image of herself with the scene. This means that, in addition to the camera, the person must also carry the tripod during the trip to the scene. This may be very cumbersome because the person may also need to carry other items (e.g., water, food, clothes) and the tripod increases the total weight. Although today's technology has made the tripod smaller and more light-weighted, it is still an item that the person needs to carry to the scene.

As an alternative to carrying the tripod, the person may ask a passerby or bystander at the scene to take the photograph for her. This avoids the problem of carrying a tripod. However, this approach still bears a number of disadvantages. One is the risk of losing the camera when entrusting it to a stranger. The passerby or bystander may run away with the camera, especially if the camera is of a very expensive type. A second disadvantage is that the passerby may not do a competent job of taking the photograph. The most common problem is that the passerby may not hold the camera steady enough when taking the photograph. Another common problem is that some portion of either the person or the scene was left out of the photograph. This may be resulted from any mis-communication between the two (e.g., the two speak different languages).

Obviously, if the camera is a digital camera, the image recorded can be immediately viewed by the person to see if it is an acceptable one. If not, the person can delete the image and ask another passerby, if any, to take another image of the person with the scene. This process can be repeated until a satisfactory image is taken or recorded. But this approach still requires that the camera be carried by the person to the scene.

### SUMMARY OF THE INVENTION

One feature of the present invention is to avoid the need to use a tripod or rely on a passerby to take images of oneself at a scene.

Another feature of the present invention is to allow remote access to an image taken at a scenic spot with privacy protection.

In accordance with one embodiment of the present invention, an Internet-enabled photographing system is provided that includes a photographing module that, when activated, records an image. A code generator generates and associates an identifying code with the image. An output module notifies the user of the photographing system the identifying code. A server (e.g., a web or email server) allows external access to the image with the identifying code via the Internet.

The Internet-enabled photographing system can be stationary or movable. The system further includes an address output module that outputs (e.g., displays, prints, or electronically transmits) the address of the server. In one embodiment, the address output module is a display. In another embodiment, the address output module is a beacon that transmits the address. In a further embodiment, the address output module may include both the display and the beacon. Moreover, the photographing system may simply have a single output sub-system that outputs (1) the captured image (e.g., thumb nail), (2) the address of the server, and (3) the code of the captured image. The single output sub-system may also print some or all of the above-mentioned information items on a ticket, or encode them on a magnetic tape or in a smart card.

In addition, the photographing system may include (1) an image store that stores the image such that the image can be remotely accessed via the web server later on, and (2) an image processor that processes the image before it is stored in the image store.

### BRIEF DESCRIPTION OF THE DRAWINGS

FIG. 1 is a perspective view of an Internet-enabled photographing system that implements one embodiment of the present invention.

FIG. 2 shows the functional structure of the Internet-enabled photographing system of FIG. 1, which includes an activation detector, a camera, a code generator, a code output module, and a web server.

FIG. 3 illustrates the structure of the activation detector 11 of the photographing system of FIGS. 1-2.

FIG. 4 shows in flowchart diagram form the operation of the Internet-enabled photographing system of FIGS. 1-2.

### DETAILED DESCRIPTION OF THE INVENTION

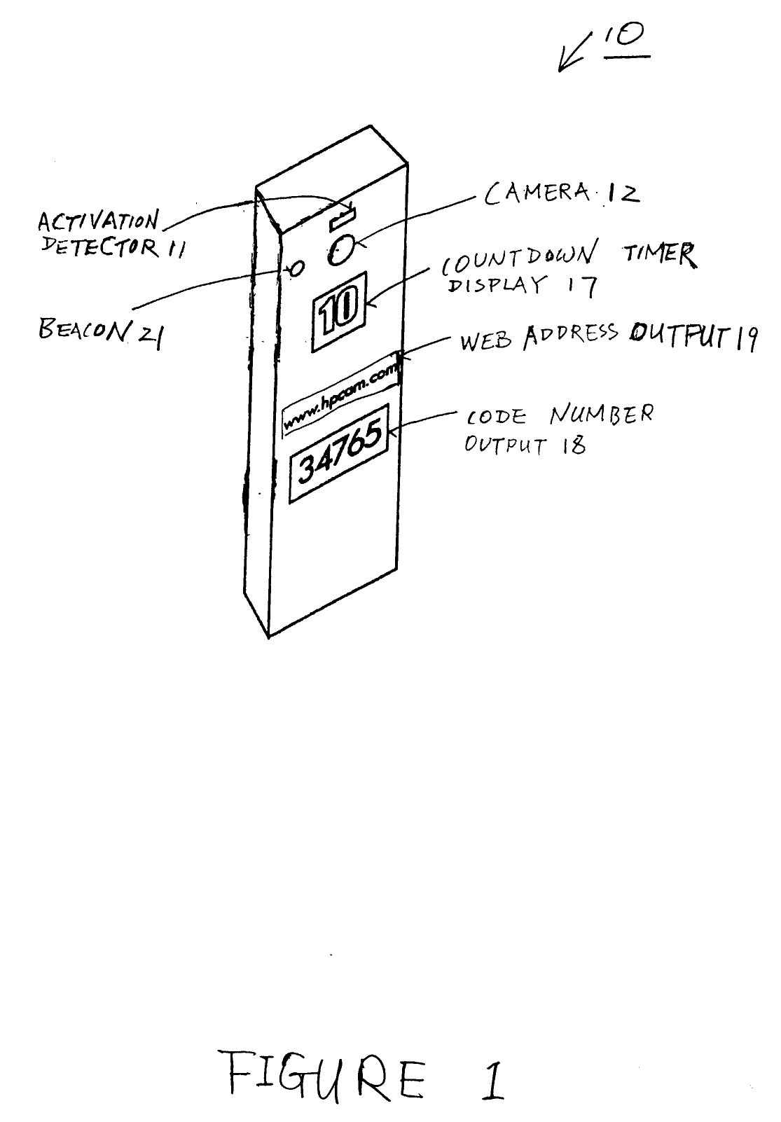

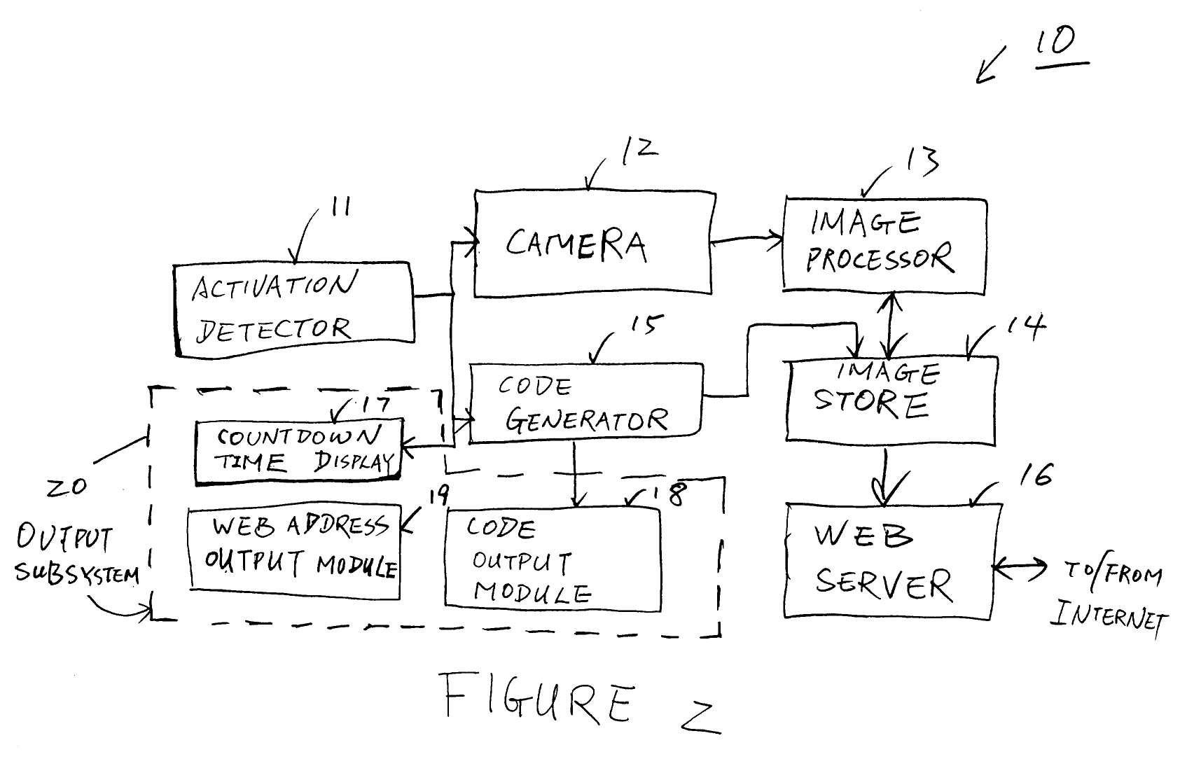

FIG. 1 shows in perspective view an Internet-enabled photographing system 10 that implements one embodiment of the present invention. FIG. 2 shows the functional structure of the Internet-enabled photographing system 10 of FIG. 1. In accordance with one embodiment of the present invention, the Internet-enabled photographing system 10 provides an automated vending-machine type service to allow a person (or persons) at a scene to take a self-image without using a tripod or relying on a passerby. In addition, the Internet-enabled photographing system 10 allows remote access to images stored in it with privacy protection.

As will be described below, the Internet-enabled photographing system 10 includes a camera (or photographing module) 12. The camera 12, when activated, records an image. The image can include the user of the photographing system 10. The image can also be a scene image without the user being in the image. A code generator 15 (shown in FIG. 2) generates and associates an identifying code with the image. A code output module 18 notifies the user of the photographing system 10 the identifying code. A web server 16 (shown in FIG. 2) is also provided in the photographing system 10 to allow external and remote access to the image with the identifying code via the Internet.

It is to be noted that the Internet-enabled photographing system 10, however, may function with some of the above-mentioned modules replaced. For example, the web server 16 may be replaced with an email server, or any other server that follows the client-server communication protocol.

In addition, the Internet-enabled photographing system 10 may include a web address output module 19 that outputs (e.g., displays, prints, or electronically transmits) the web address of the web server 16. If the web server 16 is replaced with another server (e.g., an email server), the web address output module 19 will output the address (e.g., the email address) of that server.

The Internet-enabled photographing system 10 may also include an image store 14 (shown in FIG. 2) that stores all the images taken by the camera 12 such that the images can be remotely accessed via the web server 16 later on. Both the image store 14 and the web server 16 may be located within the same enclosure as other modules of the photographing system 10, or located elsewhere but connected to the other modules of the photographing system 10 that are located within a single enclosure.

An image processor 13 can also be employed between the camera 12 and the image store 14 to process an image before it is stored in the image store 14. The Internet-enabled photographing system 10 will be described in more detail below, also in conjunction with FIGS. 1-4.

As can be seen from FIG. 1, the Internet-enabled photographing system 10 is implemented as a freestanding obelisk, according to one embodiment of the present invention. In this case, the Internet-enabled photographing system 10 is stationary. However, this does not mean that the photographing system 10 must be implemented this way. For example, the Internet-enabled photographing system 10 may be built into a wall (or into other object). As a further example, the Internet-enabled photographing system 10 may be mounted on a statue (or other anthropomorphic character). Moreover, the Internet enabled photographing system 10 may be mounted on a movable object (and thus mobile).

The camera 12 is shown in FIGS. 1 and 2. FIG. 1 actually shows the lens of the camera 12. The camera 12 can also be referred to as the photographing module (or imaging module) of the photographing system 10. The function of the camera 12 is to take, when activated, images or photographs of scenes and/or people in front of the camera 12. This function is known and will not be described in more detail below.

The camera 12 can be implemented using any known camera technology. For example, the camera 12 can be a digital camera, a conventional camera, or a video camera. If the camera 12 is a conventional camera, then a converter (or scanner) is needed to convert the recorded image into digital form. In addition, the camera 12 can have a fixed lens or variable (i.e., zoom) lens. The variable lens can also be optically and/or digitally variable.

If the camera 12 is a video camera, it can record video (either recording to video tape or storing it electronically). The video can be, for example, a ten second clip. In addition, the camera 12 may further include audio recording device (e.g., microphone) to capture audio signals along with the video.

The camera 12 may also include a flash or light source that, when triggered, can correctly light up the subject (either the scene or person).

FIGS. 1-2 only show one camera 12. However, the system 10 is not limited to one camera. For example, the photographing system 10 could include multiple cameras (or a single camera with suitable optics so it behaves like several physical cameras). These multiple cameras can be used to construct an image of panoramic view (e.g., by stitching multiple images together). These multiple cameras can also be used to obtain three-dimensional information (i.e., stereo pairs, or image depth or distance information). The three-dimensional information could be an aid to detecting subject presence, subject positions, and for focusing. This would be of considerable assistance when having artificial character's pose with the user in the picture (e.g., having an artificial parrot sitting on your shoulder).

Alternatively, the camera 12 may just be a single camera with a depth sensor (not shown) to obtain the depth information. The depth sensor can be implemented using known technology. For example, depth sensing can be implemented by briefly projecting a pattern onto the subjects and using known computer-vision technique to derive the depth information.

As a further alternative, the camera 12 may have one lens fixed focus on infinity (for the scenery) and another lens fixed short focus (for the subject). Then the images are combined electronically to form a single image with both the foreground and background in focus.

The photographing system 10 may also include an image display (not shown) that receives the image taken by the camera 12 and displays the image to the user of the system 10. Alternatively, this display function can be integrated into one of the modules of the output subsystem 20 of the photographing system 10. In addition, the photographing system 10 may include a monitor (not shown) connected to the camera 12 to allow the user of the system 10 to see what the final picture taken by the camera 12 would look like. This allows the user to adjust her position before the image is taken. The monitor may display the image as a reversed mirror image as people are more comfortable adjusting themselves with mirror images rather than true images. If characters (or other elements) are to be inserted, the monitor could provide a preview of them as well.

The photographing system 10 may also include an image analyzer (not shown) connected to the camera 12. The image analyzer may be implemented using software technology. The image analyzer analyzes artistic nature of the image to be taken by the camera 12 and outputs suggestions for the user of the photographing system 10 to improve her pose. For example, the image analyzer may analyzes the artistic nature of the pose (both of the people and of them with respect to the background), and make suggestions (e.g., “move a bit to the left”, “chin down”, etc.) in audio or visual form (e.g., arrows indications).

As can be seen from FIG. 2, the output subsystem 20 of the photographing system 10 includes a countdown time display 17 (also shown in FIG. 1), a web address output module 19, and the code output module 18. The countdown time display 17 is connected to the activation detector 11 and is used to display to the user of the system 10 the countdown time. The display 17 can be implemented using known display technology (e.g., CRT or LED).

The web address output module 19 is used to output the web address of the web server 16 of the system 10. This can be done by displaying, printing, or electronically transmitting the web address to the user of the system 10. The module 19 can be implemented using known technology. For example the module 19 can be implemented in the form of a display, a beacon that transmits electronic signals containing the web address, and/or a printer. If the module 19 is implemented as a beacon, the beacon has a predetermined transmission range and can employ a wireless communication technology (e.g., laser, short range radio, Infrared, and ultrasound).

The code output module 18 is connected to the code generator 15, and is used to output the code generated by the code generator 15. The output format of the code output module 18 can be accomplished by displaying, printing, or electronically transmitting the web address to the user of the system 10. This means that the module 18 can be implemented in the form of a display, a beacon that transmits electronic signals containing the code, and/or a printer. If the module 18 is implemented as a beacon, the beacon has a predetermined transmission range and can employ a wireless communication technology (e.g., laser, short range radio, Infrared, and ultrasound).

The code output module 18 may also include a user interface (not shown) that allows the user of the system 10 to interact with the system 10. This means that the user interface allows the user to input the user's identity information (e.g., email address, web address of the user's web site) to the web server 16 such that the image can be sent to the user. The user interface can be implemented in many way. For example, the user interface can receive information via telephone (e.g., cell phone). As a further example, the user interface can be implemented to receive the user information electronically (e.g., beaming the user information using a beacon-type of device). The user interface can also be implemented using a magnetic/optical card reader that reads information when a personal ID card, a credit card, or a driver's license swipes through it. The user interface can also be implemented using a biometric identity reader (e.g., a retina scanner, a fingerprint scanner, a facial recognition system). The user interface can also be implemented using a barcode reader.

When the output modules 18-19 are also implemented in the form of a display, the modules 17-19 can be integrated into a single display module that displays all the three items of information together. The integrated display module can also display the image taken by the camera 12.

The photographing system 10 may include a beacon 21 (shown in FIG. 1) in addition to the output subsystem 20. In this case, the beacon 21 is used to transmit the web address of the web server 16, the code generated by the code generator 15, either respectively or collectively. In this case, the modules 18-19 will not be implemented as a beacon.

As can be seen from FIG. 2, the output of the camera 12 is applied to the image processor 13. Alternatively, the system 10 does not contain the image processor 13. In this case, the output of the camera 12 is applied to the image store 14 or directly to the web server 16.

The function of the image processor 13 is to polish the image using some known image processing techniques. For example, the camera 12 can pre-take an image of the scene without any person in the image. This allows the scene image to be taken at the best moment of the environment (e.g., the Sun is at the right position, and the sky is clear with a little bit of clouds). This means that the best moment may be six o'clock in the morning or five o'clock in the evening.

This best scene image is then stored in the image store 14. When a person wants to take a picture of her with the scene, the camera 12 only takes the image of the person without the scene. Then the image processor 13 superimposes the two images together to produce a single image of the person with the best scene.

Other known image processing techniques include color compensation and red-eye elimination. The image processor 13 is implemented with known technology.

The image store 14 stores all the images taken by the camera 12. In addition, the image store 14 stores all the codes associated with each of the images taken. Each of the images stored can be accessed and retrieved using its associated code. The image store 14 is implemented using known technology.

The web server 16 is connected to the image store 14. If the system 10 does not contain the image store 14, then the web server 16 is connected to the camera 12 (either directly or via the image processor 13). In this case, the web server 16 includes a store that stores all the images taken by the camera 12. The web server 16 has its unique web address which is made to the user of the system 10 by the web address output module 19. The web server 16 can be accessed remotely via the Internet (or Intranet) using the web address. An open standard communication protocol (e.g., HTTP) may be employed for the communications to the web server 16 via the Internet.

Alternatively, the web server 16 can be any TCP/IP-based server application system. A TCP/IP-based server application is a connected-based client-server system.

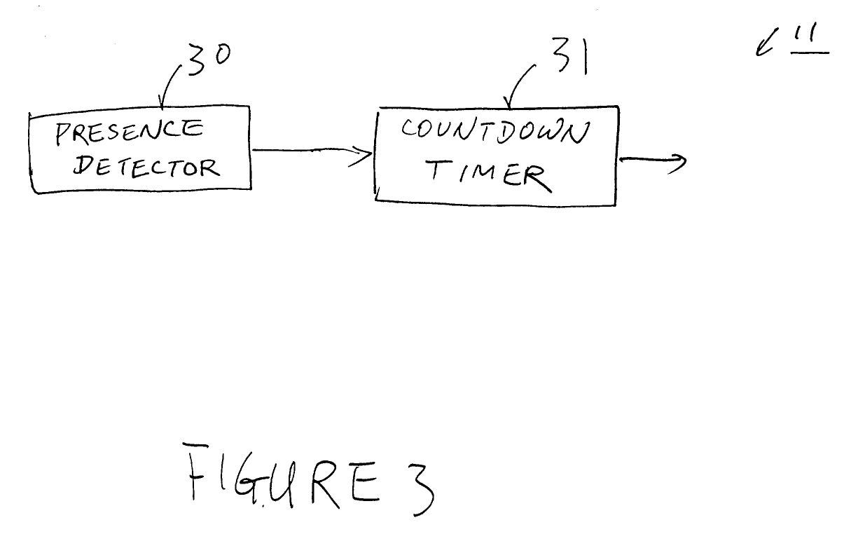

FIGS. 1-2 also show the activation detector 11. The activation detector 11 is used to detect an activation signal from the user of the system 10, and to trigger the camera 12 to take the image (or photograph) when the activation signal is detected. The activator detector 11 is connected to the camera 12 (see FIG. 2). FIG. 1 only illustratively shows the activation detector 11. As can be seen from FIG. 1, the activation detector 11 is placed on the same side of the lens of the camera 12. This is only one of the embodiments. Alternatively, the activation detector 11 can be placed on the opposite side of the lens of the camera 12 (i.e., on the back of the enclosure of the system 10). FIG. 3 shows in more detail the activation detector 11, which will be described in more detail below.

Referring again to FIGS. 1-2, during operation, the Internet-enabled photographing system 10 is placed at a scene (e.g., famous lookout site, scenic spot, or landmark) or other place at which people like to take pictures. The Internet-enabled photographing system 10 is placed facing the scene so that it is also included in the image taken by the photographing system 10.

When a user (or users) stand in front of the Internet-enabled photographing system 10 and activates the system 10, the activation detector 11 detects the activation signal from the user. This leads to the camera 12 taking the image (either immediately or after a predetermined time period specified by a countdown timer in the detector 11). At the same time, the code generator 15 is also triggered to generate a code which is associated with the image. The association can take place in the image store 14.

If the system 10 includes the image processor 13, then the image can pass through the image processor 13 to be further polished before being stored in the image store 14. The code generator 15 also sends the code to the code output module 18 such that the user of the system 10 can be informed of the associated code.

With the code, the user can then remotely access the system 10 for the image via the Internet. In this case, the system 10 may require the user to furnish proof of identity and/or payment. It is also plausible that the image taking can be free, but some retrieval (e.g., high resolution image) may require payment.

When the web server 16 receives the request with the code, the web server 16 accesses the image store 14 with the code to retrieve the associated image. Then the web server 16 either send the image back or to another site as specified in the request. This means that the user can either download the image or order a printed hard copy of the image be sent separately.

FIG. 3 shows in more detail the structure of the activation detector 11 of FIGS. 1-2. As can be seen from FIG. 3, the activation detector 11 includes a presence detector 30 and a countdown timer 31. The countdown timer 31 is connected to the presence detector 30, and is activated by the presence detector 30. The output of the countdown timer 31 is connected to the countdown timer display 17 (shown in FIGS. 1-2) of the photographing system 10 and to the camera 12 (shown in FIGS. 1-2). Both the presence detector 30 and the countdown timer 31 can be implemented using known technologies.

The presence detector 30 detects the presence of the user of the photographing system 10 (FIGS. 1-2). When the presence detector 30 detects the presence, the presence detector 30 generates the activation signal to trigger the countdown timer 31. Alternatively, the activation detector 11 does not include the countdown timer 31. In this case, the activation signal is directly applied to the camera 12 (FIGS. 1-2).

In one embodiment, the presence detector 30 is implemented as a pressure sensor (e.g., a push button either on the enclosure of the system 10 or on the marked spot on the ground where the user will stand). In another embodiment, the presence detector 30 is a motion sensor that detects motion at a specified location. In yet another embodiment, the presence detector 30 detects the presence of the user by detecting completion of a user action (e.g., depositing coins, swiping a charge card for payment, etc.). Alternatively, the presence detector 30 is an audio sensor that can be triggered with an audio indication. The audio sensor may include a simple speech recognition function to distinguish the audio indication from noise. The audio sensor can also be replaced with a visual sensor (plus a face recognition function).

As described above, the activation detector 11 can be placed on the opposite side of the lens of the camera 12 (i.e., on the back of the enclosure of the system 10). This means to place the presence detector 30 on the opposite side. In this case, the presence detector 30 can still be a pressure sensor (e.g., a push button) or motion sensor. The reason for putting the presence detector 30 on the opposite side is to allow the Internet-enabled photographing system 10 to take an image of the scene without any person in the image.

The countdown timer 31 is activated by the presence detector 30 to start counting down for a predetermined time period. In one embodiment, the predetermined time period is fifteen seconds. In other embodiments, the predetermined time period can be longer or shorter than fifteen seconds. For example, the predetermined time period can be ten or twenty seconds.

When it counts down to zero, the countdown timer 31 generates a trigger signal that causes the camera 12 (FIGS. 1-2) to take an image. In addition, the output of the countdown timer 31 is also applied to the countdown timer display 17 (FIGS. 1-2) so that the user can know when the camera 12 will be triggered to take an image and thus get ready for it.

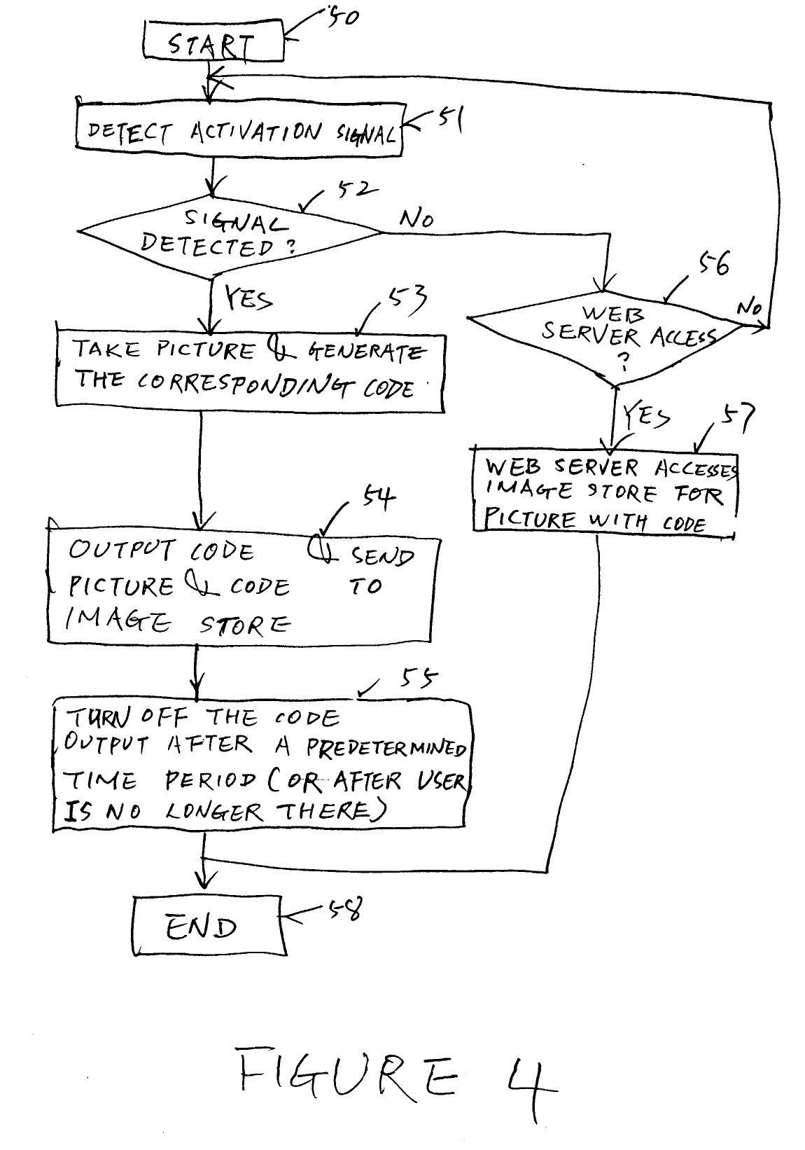

FIG. 4 is a flowchart diagram showing the operational process of the Internet-enabled photographing system 10 of FIGS. 1-3. Although the steps are described in sequential order, it does not mean that they are executed in sequential order. Some of the steps can be executed in independently in parallel. For example, the camera control and the server operations are run independently in parallel.

As can be seen from FIG. 4, the process starts at the step 50. The steps 51 and 52 are for detecting the activation signal. The step 51 is a detection step and the step 52 is a judgment step to determine if the activation signal has been detected. Both of the steps 51-52 are performed by the activation detector 11 (shown in FIGS. 1-3).

At the step 53, the system 10 causes the image to be taken and the corresponding code to be generated. The image is taken by the camera 12 (see FIGS. 1-2) and the code generator 15 generates the corresponding code. As described above, the code is used to search and identify the image.

At the step 54, the code output module 18 (shown in FIG. 2) of the Internet-enabled photographing system 10 outputs the code (i.e., makes the code known to the user of the system 10). In addition, the image store 14 (shown in FIG. 2) stores the image and the associated code at the step 54. At the step 55, the system 10 turns off the output of the code output module 18 (shown in FIGS. 1-2) after a predetermined time period (e.g., fifteen seconds or thirty seconds). This is to prevent the code from being known to others (i.e., privacy protection). Alternatively, the system 10 turns off the output of the code output module 18 (FIGS. 1-2) after it has detected that the user of the system 10 is no longer there. This can be realized using a presence detector or sensor. The process then ends at the step 58.

If, at the step 52, it is determined that no activation signal is detected, then the process moves to the step 56. At the step 56, it is determined whether a web server access request is received in the web server 16 (shown in FIG. 2). The access request includes a particular code, identifying the associated photo that the requester wants. If it is determined at the step 56 that there is no web server access request received, the process returns to the step 51. Otherwise, the step 57 is performed.

At the step 57, the web server 16 accesses the image store 14 with the code received to locate and retrieve the corresponding image. When the corresponding photo is retrieved, the web server 16 sends the image to the remote requester via the Internet. The process then ends at the step 58.

In the foregoing specification, the invention has been described with reference to specific embodiments thereof. The specification and drawings should, however, be regarded in an illustrative rather than a restrictive sense.

What is claimed is:

1. An Internet-enabled photographing system, comprising:
a photographing module that, when activated, records an image;
a code generator that generates and associates an identifying code with the image;
an output module that notifies the user of the photographing system the identifying code;
a server that allows external access to the image with the identifying code via the Internet.

2. The photographing system of claim 1, wherein all modules of the photographing system reside in a single enclosure which is stationary.

3. The photographing system of claim 1, wherein all modules of the photographing system reside in a single enclosure which is movable.

4. The photographing system of claim 1, further comprising an address output module that outputs the address of the server.

5. The photographing system of claim 4, wherein the address output module is selected from a group comprising a display, a beacon that transmits electronic signals containing the address, a printer, a magnetic recorder, and a smart card recorder.

6. The photographing system of claim 5, wherein the beacon has a predefined transmission range and employs a wireless communication technology selected from a group comprising laser, short range radio, Infrared, and ultrasound.

7. The photographing system of claim 4, wherein the server is one of a web server and an email server.

8. The photographing system of claim 1, wherein the output module (1) displays the identifying code, (2) displays the address of the server, and (3) displays the image.

9. The photographing system of claim 1, wherein the output module is selected from a group comprising a display, a beacon that transmits electronic signals containing the address, a printer, a magnetic recorder, and a smart card recorder.

10. The photographing system of claim 9, wherein the beacon has a transmission range and employs a wireless communication technology selected from a group comprising laser, short range radio, Infrared, and ultrasound.

11. The photographing system of claim 1, further comprising an activation detector coupled to the photographing module to detect an activation signal, and to trigger the photographing module to take an image when the activation signal is detected.

12. The photographing system of claim 11, wherein the activation detector further comprises
a presence detector that detects presence of the user when the user is in front of the photographing system, wherein the presence detector generates the activation signal when detecting the presence of the user;
a countdown timer coupled to the presence detector and the photographing module to start counting for a predetermined time period when receiving the activation signal from the presence detector, and to trigger the photographing module to take an image when the predetermined time period has lapsed.

13. The photographing system of claim 12, wherein the presence detector is selected from a group comprising a push-down switch, a pressure sensor, a motion sensor, an audio sensor with a speech recognition function, and a visual sensor with a face recognition function.

14. The photographing system of claim 12, wherein the presence detector detects the presence of the user by detecting completion of a user action for depositing coins or swiping a charge card for payment.

15. The photographing system of claim 12, wherein the presence detector is on an opposite side of lens of the photographing module.

16. The photographing system of claim 1, wherein the photographing module further comprises multiple cameras such that the image produced includes depth information.

17. The photographing system of claim 1, wherein the photographing module further comprises a depth sensor that detects distance information from the scene.

18. The photographing system of claim 1, further comprising an image store coupled to the server to store the image and its associated code before they are sent to the server.

19. The photographing system of claim 18, further comprising an image processor coupled to the photographing module and the image store to process the image taken by the photographing module.

20. The photographing system of claim 1, further comprising an image analyzer coupled to the camera that analyzes artistic nature of the image to be taken by the photographing module and outputs suggestions for the user of the photographing system to improve her pose.

21. The photographing system of claim 1, further comprising a monitor coupled to the photographing module to allow the user of the photographing system to see what the final image would look like.

22. The photographing system of claim 1, further comprising an image display coupled to the photographing module to display to the user the image taken by the photographing module.

23. The photographing system of claim 1, wherein the output module further comprises a user interface to acquire user identity, and to route the image to the user using the user identity.

24. The photographing system of claim 23, wherein the user interface also allows the user to present proof of the acquired user identity, and to send encryption key to the server such that the image sent can be encrypted that can be decrypted by the user.

25. The photographing system of claim 1, wherein the image includes the user of the photographing system.

26. The photographing system of claim 1, wherein the image is of a scene without the user of the photographing system.
